(19) United States
(12) Patent Application Publication
(10) Pub. No.: US 2018/0214823 A1
(43) Pub. Date: Aug. 2, 2018

(54) A System and Method for Treating Air for a Vehicle Cab

(71) Applicant: AGCO International GmbH, Neuhausen (CH)

(72) Inventors: Cyrille Faudry, Beauvais (FR); Pierre Bertrand, Beauvais (FR)

(21) Appl. No.: 15/749,339

(22) PCT Filed: Aug. 2, 2016
(86) PCT No.: PCT/EP2016/068395

§ 371 Date: Jan. 31, 2018

(30) Foreign Application Priority Data
Aug. 3, 2015 (EP) 15290200.3

(51) Int. Cl. B01D 53/66; B01D 53/76; B60H 1/00; B60H 3/00; B01D 53/04

(52) U.S. Cl. CPC B01D 53/66; B01D 53/76; B60H 1/00378; B60H 3/0035; B60H 2003/0691; B01D 2251/104; B01D 2253/102; B01D 2257/90; B01D 2257/91; B01D 53/0454

(57) ABSTRACT

A method and system for ozone treatment of air for a vehicle cab where the system monitors the level of ozone in treated air, and is arranged to perform further treatment of the treated air if the detected ozone levels exceed a threshold level. Such further treatment may include adjusting the flow rate of air in the system, recirculating the treated air through an air filter to remove ozone from the treated air; providing an ozone-reducing substance to the treated air to lower the level of ozone in the treated air, and/or ejecting at least a portion of the treated air to the environment.

### BACKGROUND OF THE INVENTION

### Field of the Invention

The present invention relates to a system and method for treating air for a vehicle cab, in particular through the supply of ozone to air for a vehicle cab.

### Discussion of Related Art

In many vehicle applications, vehicle operators and passengers are located in a vehicle cab, which can be sealed from the external environment. Vehicle cabs accordingly require a supply of air to the cab interior, which can be filtered and treated as appropriate.

It is known to supply ozone (O₃) to such an air supply, in an effort to cleanse the air supply before reaching the vehicle cab. However, as ozone is a powerful oxidant, in relatively high concentrations it can react with a variety of substances and also cause respiratory problems in vehicle operators or passengers. In addition, ozone has a noticeable pungent smell. Such characteristics have prevented widespread usage of ozone for vehicle cab air treatment systems. An example of an air purification system can be seen in US Patent Application Publication No. US2010/0172793.

It is an object of the invention to provide a system and method for the treatment of vehicle cab air which addresses the above issues.

### SUMMARY OF THE INVENTION

Accordingly, there is provided a method of treating air for a vehicle cab, the method comprising the steps of:
providing a supply of intake air for a vehicle cab;
supplying ozone to said intake air to provide treated air; and
supplying said treated air to the vehicle cab,
   wherein the method further comprises the steps of:
determining the level of ozone in said treated air, and
   if the detected ozone level is below a threshold level of ozone, supplying said treated air to the vehicle cab, or
   if the detected ozone level is above the threshold level of ozone, carrying out a further treatment operation on the treated air.

The method provides a system for the safe supply of ozone-treated air to a vehicle cab, which incorporates a feedback system to ensure that the ozone levels in air to be supplied to the cab can be accurately controlled and regulated. The threshold levels indicated can be understood to be a primary threshold, to determine whether or not the treated air can be safely provided to a vehicle cab. The step of supplying the treated air to the vehicle cab will be understood as providing the treated air directly to a cab interior, or supplying the treated air to an inlet of a cab HVAC system, for eventual supply to the cab interior. It will be understood that the ozone may be supplied to air received direct from an air intake, or the ozone may be supplied to conditioned air which is provided from a vehicle HVAC system. Accordingly, the intake air may be taken directly from the external atmosphere, or from the output of a vehicle HVAC system. As a result, the system and method can be performed as part of a vehicle HVAC system, or as part of a retrofitted solution for a vehicle.

Preferably, the step of determining the level of ozone comprises detecting the level of ozone in the treated air, e.g. using an ozone sensor. Additionally or alternatively, the step of determining the level of ozone may comprise calculating the level of ozone in the treated air. Such calculating may be based on any number of factors, e.g. monitored ozone generation levels from an ozone generator; detected levels of other substances in the treated air; flow rates of the intake air and/or the treated air.

Preferably, the further treatment operation comprises at least one of the following steps:
adjusting the flow rate of the intake air;
adjusting the flow rate of the treated air;
recirculating the treated air through an air filter to remove ozone from the treated air;
providing an ozone-reducing substance to the treated air to lower the level of ozone in the treated air; or
ejecting at least a portion of the treated air to the environment.

By carrying out at least one of the above treatment operations, the level of ozone in the treated air for supply to the vehicle cab can be regulated. Preferably, the air filter is a carbon-based or activated carbon air filter. The ozone-reducing substance can be understood to be a material which reacts with ozone in air to remove ozone from the air. The step of providing can include injecting a substance into the treated air, e.g. a liquid or gaseous substance. The step of providing can also include arranging the treated air to come into contact with an ozone-reducing substance, e.g. a solid or pellet-based material.

Preferably, the further treatment operation additionally comprises:
adjusting the rate of ozone supply to the intake air.

Preferably, the method comprises the step of, if the detected level of ozone is above the threshold level of ozone for a defined period of time, generating a service notification.

If the supplied ozone levels are in excess of the threshold level for a defined period of time, this may be indicative of a fault in the system supplying the ozone, or in another area of the treatment system. In this case, the presence of relatively high ozone levels in the system can be used as the basis to prompt a service inspection, and possible repair, of the associated system.

In a preferred embodiment, the method comprises the step of comparing the detected ozone level to an upper threshold level of ozone and a lower threshold level of ozone, the lower threshold level less than the upper threshold level, wherein:
when the detected level of ozone is greater than the lower threshold and less than the upper threshold, a first treatment operation is performed, and
when the detected level of ozone is greater than the upper threshold, a second treatment operation is performed.

By providing different threshold levels, the effectiveness of the control of the system can be improved. For example, if the lower threshold is reached, a first series of treatment operations may be performed, while if the upper threshold is reached a second set of treatment operations, having a relatively faster response time, may be triggered, to provide a faster reduction in the level of ozone supplied to the vehicle cab. Such upper and lower threshold levels may be understood as a secondary threshold system, to control system performance. In a preferred aspect, the lower secondary threshold is equivalent to the primary threshold level, indicative of a safe level of ozone for supply to a vehicle cab. It will be understood that the second treatment operation is different to the first treatment operation.

It will be understood that the lower threshold level may correspond to a non-hazardous, but detectable, level of ozone in air, e.g. approximately 10 ppb. Additionally or alternatively, the upper threshold level may correspond to a potentially hazardous level of ozone of ozone in air, e.g. approximately 100 ppb.

Preferably, the first treatment operation comprises at least one of the following:
adjusting the flow rate of the intake air;
adjusting the flow rate of the treated air; or
recirculating the treated air through an air filter to remove ozone from the treated air.

Such operations can act to reduce the level of ozone in the treated air, while still allowing treated air to be supplied to the cab. The first treatment operation may also comprise adjusting the rate of ozone supply to the intake air.

Preferably, the second control operation comprises at least one of the following:
recirculating the treated air through an air filter to remove ozone from the treated air;
providing an ozone-reducing substance to the treated air to lower the level of ozone in the treated air; or
ejecting at least a portion of the treated air to the environment.

Such operations can be controlled to prevent such relatively hazardous levels of ozone from being supplied to the vehicle cab. Such fast-response operations can be carried out until the detected level of ozone falls below the upper threshold level. The ozone-reducing substance can be understood to be a material which reacts with ozone in air to remove ozone from the air. The step of providing can include injecting a substance into the treated air, e.g. a liquid or gaseous substance. The step of providing can also include arranging the treated air to come into contact with an ozone-reducing substance, e.g. a solid or pellet-based material.

Preferably, the method comprises the step of filtering the intake air prior to the step of supplying ozone to treat the intake air.

Preferably, the method comprises the step of filtering the treated air after the step of supplying ozone to treat the intake air.

Preferably, said step of detecting is performed after the step of filtering the treated air.

The use of air filters can act to remove dust or other debris from the air supply, and can also be used to reduce the level of ozone in the treated air.

There is further provided an ozone treatment system for a vehicle cab arranged to implement the steps of the above method.

Preferably, there is provided an ozone treatment system for a vehicle cab, the system comprising:
an air intake;
an ozone generator to supply ozone to intake air to provide treated air;
a system for determining the level of ozone in said treated air; and
an outlet for the treated air,
   the system further comprising a controller arranged to receive the output of the determining system, wherein the controller is operable to control system operation such that:
if the determined ozone level is below a threshold level of ozone, the controller is arranged to supply said treated air to the outlet, or
if the determined ozone level is above the threshold level of ozone, the controller is operable to perform a further treatment operation on the treated air.

The system for determining the level of ozone in said treated air can comprise a sensor for detecting the level of ozone in said treated air. Additionally or alternatively, the system for determining the level of ozone in said treated air can comprise a processor for calculating the level of ozone in the treated air based on at least one of the following factors: monitored ozone generation levels from an ozone generator; detected levels of other substances in the treated air; flow rates of the intake air and/or the treated air.

The system may further comprise sensors arranged to detect the presence of pollutants in the intake air or the treated air. Such sensor may be operable to detect the level of pollutants in the air, wherein the controller is arranged to operate based on the output of such pollutant sensors.

Preferably, the system comprises a blower, wherein the controller is arranged to adjust the blower operation as part of a control operation. The blower may be controlled to blow in a reverse direction, for example to provide for the evacuation of air having excess ozone levels.

The blower is preferably arranged before the ozone generator, and is configured to produce a flow of intake air through the ozone generator. The blower may be controlled to operate at a reduced flow rate, or can be switched off, in the event of relatively high detected levels of ozone.

Preferably, the system comprises an adjustable baffle or valve, wherein the controller is arranged to actuate said baffle or valve to redirect a flow of the treated air as part of a control operation.

The baffle or valve is configured to redirect at least a portion of the treated airflow in the event of relatively high detected levels of ozone. Such redirected flow may be recirculated through an air filter, or combined with an additional airflow, to reduce or dilute ozone levels in the treated air.

Preferably, the system comprises an intake filter arranged to filter intake air prior to supplying ozone to the intake air.

Preferably, the system comprises an outlet filter arranged to filter treated air after supplying ozone to provide treated air.

There is further provided a vehicle, preferably an agricultural vehicle, preferably an agricultural tractor, sprayer or applicator machine, having an ozone treatment system as described above.

In one aspect, the outlet of the ozone treatment system is coupled with an inlet of a vehicle HVAC system.

In an alternative aspect, the outlet of the ozone treatment system is coupled with an inlet to a vehicle cab.

### BRIEF DESCRIPTION OF THE DRAWINGS

Embodiments of the invention will now be described, by way of example only, with reference to the accompanying drawings, in which:

FIG. 1 is an illustration of an agricultural tractor according to an aspect of the invention;

FIG. 2 shows a series of configurations of an ozone treatment system according to the invention when installed in a vehicle;

FIG. 3 is a schematic of an ozone treatment system according to an embodiment of the invention;

FIG. 4 is a plot of the operation of the ozone treatment system of FIG. 3 in a first embodiment, and

FIG. 5 is a plot of the operation of the ozone treatment system of FIG. 3 in a second embodiment.

It will be understood that the accompanying drawings are provided as representative diagrammatic figures, and are not to scale.

### DETAILED DESCRIPTION OF THE INVENTION

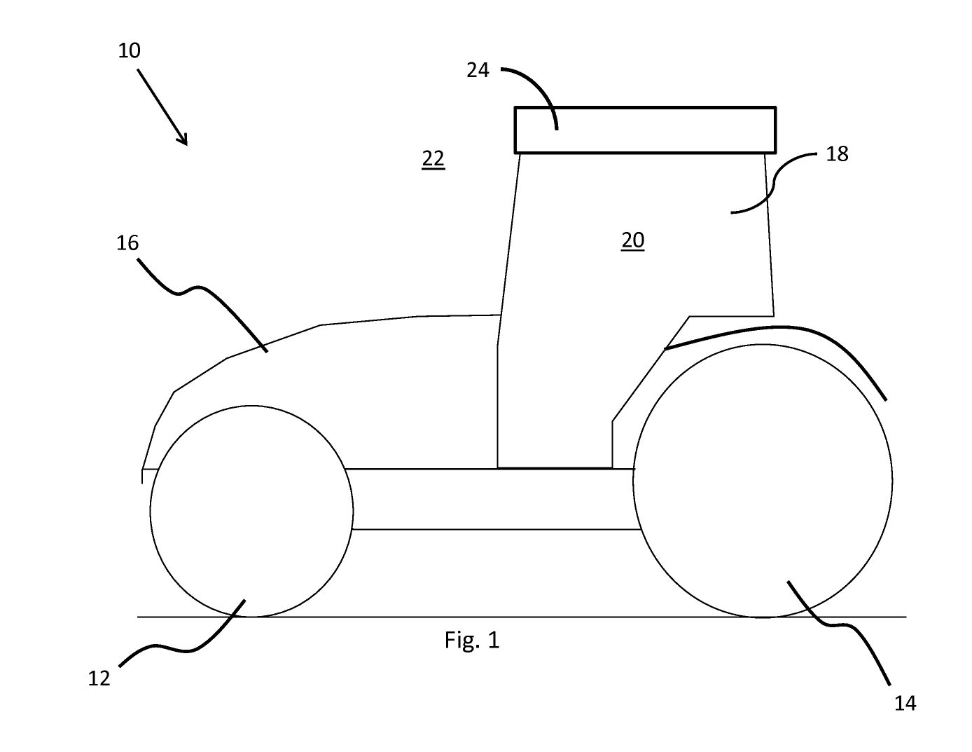

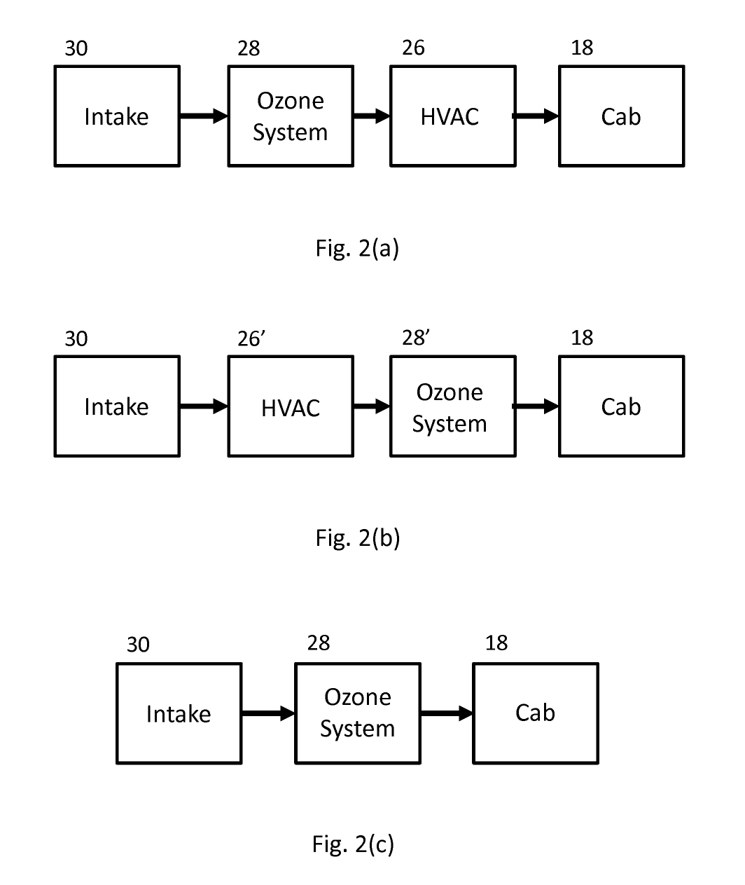

With reference to FIG. 1, a vehicle according to the invention in the form of an agricultural tractor is indicated at 10. The tractor 10 comprises front wheels 12 and rear wheels 14, a forward engine section 16 and a cab section 18. The cab section 18 defines an internal space 20 in which a tractor operator is seated during vehicle operation. The internal space 20 is substantially sealed from the ambient environmental conditions 22 exterior to the cab section 18. The cab section 18 is provided with a cab roof unit 24. A vehicle HVAC system (26, FIG. 2(a)) may be provided in the roof unit 20, but it will be understood that the HVAC system 26 may be provided in any other suitable location on the tractor 10, e.g. beneath the cab section 18. In addition, the tractor 10 is provided with an ozone treatment system (28, FIGS. 2 & 3), which may similarly be located in the roof unit 20, within or beneath the cab section 18, or in any other suitable location on the tractor 10.

FIG. 2 illustrates some possible configurations of the system of the invention. In FIG. 2(a), the tractor 10 is provided with an air intake 30, which is arranged to draw in air from the external environment 22. The intake air is passed to the ozone treatment system 28, which acts to supply ozone to treat the intake air. This results in treated air, which has been disinfected and purified relative to the original air intake. The treated air can then be passed to the vehicle HVAC system 26, where it can be heated or cooled as appropriate. The air is then supplied to the internal space 20 of the cab 18, through a suitable arrangement of grilles or vents. The use of the ozone treatment system 28 to supply treated air to the vehicle HVAC system 26 reduces the presence of harmful bacteria and odours in the HVAC system 26 and cab 18, which both prolongs the service life of the HVAC system 26 and provides for improved operator comfort.

A similar system is illustrated in FIG. 2(b), wherein the vehicle HVAC system 26′ is connected to the intake 30, with the ozone treatment system 28′ arranged downstream of the vehicle HVAC system 26′ before connection to the cab 18. In this embodiment, ozone can be supplied to conditioned air provided from the HVAC system 26′, before the treated air is provided to the cab 18.

While in the configuration of FIG. 2(a), the ozone treatment system 28 is connected in series with an inlet of the vehicle HVAC system 26, in the configuration of FIG. 2(c), the ozone system 28 is connected to supply treated air directly to the internal space 20 of the cab 18. Such a configuration may be provided in parallel with a suitable HVAC system, and may be used in configurations wherein the ozone treatment system 28 is provided as a retrofit solution to an existing vehicle.

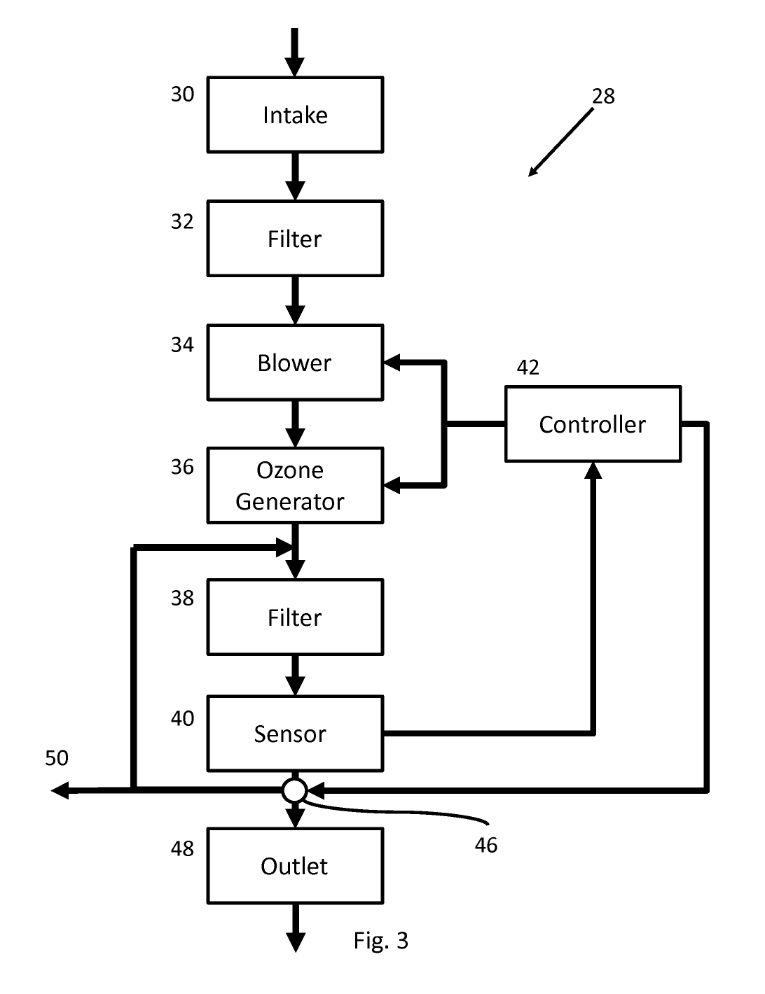

FIG. 3 illustrates a configuration of an ozone treatment system 28 according to an embodiment of the invention. The system 28 comprises an inlet arranged to receive an air intake 30, which can be received from the external environment 22. The intake air is passed through an intake air filter 32, to remove any dust or other debris from the air. The intake air filter 32 may comprise a grille or grating, or any other suitable permeable membrane arranged to remove debris from an air stream, e.g. paper, foam, cotton, etc. In addition, the intake air filter may comprise an activated or ionised filer to remove substances from the air stream.

The system 28 comprises a blower 34 arranged downstream of the filter 32, the blower 34 acting to draw in the intake air and to convey the air further through the system 28. The blower 34 blows the filtered intake air through an ozone generator 36.

The ozone generator 36 supplies ozone to the intake air, which acts to purify and disinfect the intake air, providing treated air which can be supplied to the interior of the vehicle cab 18. The supply of ozone removes harmful bacteria from the air, as well as phytochemical or chemical products and atmospheric pollutants, and can act to de-odourise the original intake air.

The treated air is then passed through an outlet air filter 38, which is configured to remove excess ozone from the air. Preferably, the outlet air filter 38 comprises an adsorption filter, e.g. an activated carbon or charcoal filter.

Once the treated air passes through the outlet filter 38, a sensor 40 is provided to monitor the level of ozone present in the filtered, treated air. The sensor 40 is coupled with a controller 42, which is arranged to regulate the operation of at least one of the blower 34, the ozone generator 36, or an adjustable valve or baffle 46 provided downstream of the sensor 40. The controller 42 acts to adjust the operation of the system 28, to ensure that the ozone levels of the treated air are within acceptable levels. While the present embodiment uses a sensor 40 to monitor ozone levels in the treated air, it will be understood that the system may be configured additionally or alternatively to determine the level of ozone in the treated air through calculation or other determining methods. For example, such calculating may be based on any number of factors, e.g. monitored ozone generation levels from an ozone generator; detected levels of other substances in the treated air; flow rates of the intake air and/or the treated air. Such calculating or determining methods may be performed using a processor, e.g. controller 42. In such a configuration, the system 28 may not require the use of dedicated sensor 40.

An outlet 48 is arranged downstream of the adjustable valve or baffle 46, through which the treated air can be passed to a vehicle HVAC system (26, FIG. 2(a)) or directly to the vehicle cab itself (18, FIG. 2(c)).

The adjustable valve or baffle 46 is configured to selectively redirect at least a portion of the flow of treated air downstream of the sensor 40. In the embodiment shown in FIG. 3, the valve 46 is operable to redirect airflow through the valve such that the airflow can be recirculated through the outlet filter 38, or that the airflow is ejected from the system 28 to the external environment 22 through a secondary outlet indicated at 50.

While not illustrated in FIG. 3, it will be understood that the ozone treatment system 28 may comprise a secondary blower arranged downstream of the ozone generator 36, which is used to control the flow rate of the treated air. It will be understood that the flow rate of such a secondary blower may also be regulated by the controller 42.

It will be further understood that the series arrangement of the components of the system 28 may be adjusted as appropriate, without departing from the principle of the invention. For example the sensor 40 may be positioned downstream of the adjustable valve 46.

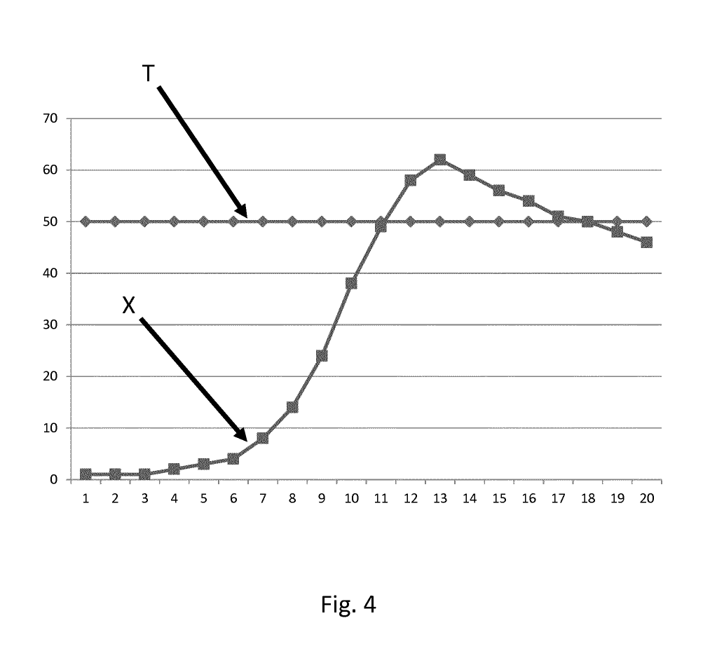

The controller 42 can regulate the system operation, to ensure that the ozone levels of the treated air are within acceptable levels. With reference to FIG. 4, a first method of operation of the system 28 is now described. FIG. 4 is a sample plot of the level of ozone in the treated air over time detected by the sensor 40, indicated at X. The controller 42 is arranged to monitor the detected level of ozone, and when the ozone level reaches a threshold, indicated at T, the controller 42 is operable to perform further treatment of the treated air.

It will be understood that the threshold T may be indicative of a safety level of ozone in the treated air, above which it is desired to reduce the level of ozone in the treated air. The threshold level may be any suitable level of ozone, e.g. 5 ppb (parts per billion), 10 ppb, 20 ppb, 50 ppb, etc.

Once the controller 42 judges that the level of ozone exceeds the threshold, the controller instructs the system 28 to perform at least one further treatment operation to reduce the level of ozone in the treated air. Such a further treatment operation may include, but is not limited to, at least one of the following: adjusting the flow rate of the intake air by regulation of the blower 34; adjusting the flow rate of the treated air by regulation of a secondary blower (not shown); recirculating the treated air through air filter 38 via adjustable valve 46; injecting an ozone-reducing substance into the treated air to lower the level of ozone in the treated air, for example a liquid or gaseous substance; arranging for the treated air to come into contact with an ozone reducing substance, e.g. an ozone-reducing substance in solid or pellet form; or ejecting at least a portion of the treated air through outlet 50 via adjustable valve 46. In addition, the controller 42 may be configured to adjust the rate of ozone supply to the intake air, by controlling the operation of the ozone generator 36. It will be further understood that the controller 42 may be configured to allow for user-controlled adjustment of ozone concentration. Such user-controlled adjustment may be allowed within predefined concentration limits.

Through effective control of the elements of the system 28, the level of ozone detected in the treated air can be reduced as shown in FIG. 4, allowing the system 28 to operate with a feedback control system.

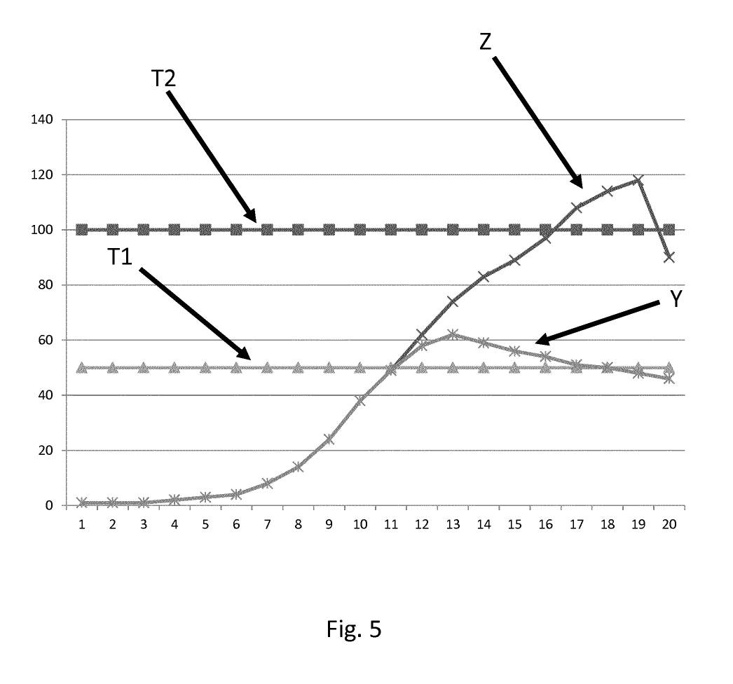

A further embodiment of a control method according to the invention is illustrated by FIG. 5, showing a sample plot of the level of ozone in the treated air over time detected by the sensor 40. In this embodiment, the controller 42 is provided with two threshold values—a lower threshold T1 and an upper threshold T2.

It will be understood that the lower threshold level T1 may be selected to correspond to a non-hazardous, but detectable, level of ozone in air, e.g. approximately 10 ppb, 25 ppb, 50 ppb. By contrast, the upper threshold level T2 may correspond to a potentially hazardous level of ozone of ozone in air, e.g. approximately 55 ppb, 100 ppb, 150 ppb.

During operation of the system 28, the controller 42 is arranged to regulate the system 28 to perform a first treatment operation if the detected ozone levels exceed the lower threshold T1, and a second treatment operation if the detected ozone levels exceed the upper threshold T2. This allows for greater control of the system performance, as the type of treatment operation can be selected based on the level of danger of the ozone concentration in the treated air. Accordingly, ozone levels in excess of the lower threshold T1 are not immediately harmful, and can be adjusted through simple feedback regulation of the system 28, e.g. control of flow speed, rate of ozone generation, etc. By contrast, any detected levels in excess of the upper threshold T2 can require immediate correction using a relatively fast response operation, e.g. recirculation or ejection of treated air, or provision of an ozone-reducing substance to relatively quickly reduce the amount of ozone in the treated air. It will be understood that detected ozone levels below the lower threshold T1 are indicative of a safe level of ozone in the treated air, and may be safely provided to a vehicle cab.

It will be understood that the first treatment operation may comprise at least one of the following: adjusting the flow rate of the intake air by regulation of the blower 34; adjusting the flow rate of the treated air by regulation of a secondary blower (not shown); or recirculating the treated air through air filter 38 via adjustable valve 46. In addition, the first treatment operation may further comprise adjusting the rate of ozone supply to the intake air from the ozone generator 36. In addition the second control operation may comprise at least one of the following: recirculating the treated air through air filter 38 via adjustable valve 46; injecting an ozone-reducing substance into the treated air to lower the level of ozone in the treated air, for example a liquid or gaseous substance; arranging for the treated air to come into contact with an ozone reducing substance, e.g. an ozone-reducing substance in solid or pellet form; or ejecting at least a portion of the treated air through outlet 50 via adjustable valve 46.

As can be seen in FIG. 5, two sample plots of detected ozone levels are shown at Y and Z. In plot Y, once the detected ozone levels exceed the lower threshold T1, the controller is operable to perform a first treatment operation, allowing for a feedback control of the ozone levels in the treated air, to settle to a steady state at or below the lower threshold level T1. By contract, in plot Z, the detected ozone levels continue to rise above the hazardous upper threshold level T2. In this case, the controller 42 activates a second treatment operation via the adjustable valve 46, e.g. recirculation or ejection of the treated air, resulting in a fast response time for reduction of ozone in the treat air.

It will be understood that the threshold levels T,T1,T2 may be predefined in the controller 42, or may be user-adjustable depending on operator requirements or sensitivity.

It will be understood that the scales shown in FIGS. 4 and 5 are not limiting, and are provided for illustrative purposes.

In a further aspect, the controller 42 is operable to display alerts to an operator of the vehicle, to indicate system performance. In a preferred aspect, if the detected levels of ozone in the treated air are measured to be in excess of a threshold level T,T1,T2 for a continued period of time after a treatment operation has been instructed by the controller 42, accordingly the controller 42 may present a service alert to a vehicle operator, indicating that a service and possible cleaning or repair of the system 28 is required. Further examples of possible alerts that can be provided to an operator by the controller 42 can include an impending stopping of the ozone supply system (e.g. based on a stopping of a spray application process), or a service request.

The use of the above system and method provides for an ozone treatment system for a vehicle having improved regulation and safety controls.

The invention is not limited to the embodiments described herein, and may be modified or adapted without departing from the scope of the present invention.

1. A method of treating air for a vehicle cab, the method comprising the steps of:
providing a supply of intake air for a vehicle cab;
supplying ozone to said intake air to provide treated air; and
determining the level of ozone in said treated air, wherein
if the determined ozone level is below a primary threshold level of ozone,
supplying said treated air to the vehicle cab, or
if the determined ozone level is above the primary threshold level of ozone,
carrying out a further treatment operation on the treated air, characterised in that the further treatment operation comprises the steps of
comparing the determined ozone level to an upper secondary threshold level of ozone and a lower secondary threshold level of ozone, the lower secondary threshold level less than the upper secondary threshold level, wherein:
when the determined level of ozone is greater than the lower secondary threshold level and less than the upper secondary threshold level, a first treatment operation is performed, and
when the determined level of ozone is greater than the upper secondary threshold level, a second treatment operation is performed,
wherein:
the first treatment operation comprises at least one of the following:
adjusting the flow rate of the intake air;
adjusting the flow rate of the treated air; and
recirculating the treated air through an air filter to remove ozone from the treated air.

2. (canceled)

3. The method of claim 1, wherein the step of determining the level of ozone in the treated air comprises calculating the level of ozone in the treated air based on at least one of the following factors: monitored ozone generation levels from an ozone generator; detected levels of other substances in the treated air; and flow rates of the intake air and/or the treated air.

4. The method of claim 1, wherein the further treatment operation comprises at least one of the following steps:
adjusting the flow rate of the intake air;
adjusting the flow rate of the treated air;
recirculating the treated air through an air filter to remove ozone from the treated air;
injecting an ozone-reducing substance into the treated air to lower the level of ozone in the treated air; and
ejecting at least a portion of the treated air to the environment.

5. The method of claim 4, wherein the further treatment operation additionally comprises:
adjusting the rate of ozone supply to the intake air.

6. The method of claim 1, wherein the method comprises a step of, if the determined level of ozone is above the primary threshold level of ozone for a defined period of time, generating a service notification.

7. The method of claim 1, wherein the lower secondary threshold level of ozone is equivalent to the primary threshold level of ozone.

8. (canceled)

9. The method of claim 1, wherein the further treatment operation comprises at least one of the following:
recirculating the treated air through an air filter to remove ozone from the treated air;
injecting an ozone-reducing substance into the treated air to lower the level of ozone in the treated air; and
ejecting at least a portion of the treated air to the environment.

10. The method of claim 1, wherein the method comprises the step of filtering the intake air prior to the step of supplying ozone to treat the intake air.

11. The method of claim 1, wherein the method comprises the step of filtering the treated air after the step of supplying ozone to treat the intake air.

12. The method of claim 11, wherein said step of determining is performed after the step of filtering the treated air.

13. The method of claim 1, wherein the lower secondary threshold level is selected from one of the following: 10 ppb, 25 ppb, 50 ppb of ozone; and the upper secondary threshold level is selected from one of the following: 55 ppb, 100 ppb, 150 ppb of ozone.

14. An ozone treatment system for a vehicle cab, the system comprising:
an air intake;
an ozone generator to supply ozone to intake air to provide treated air;
a system for determining the level of ozone in said treated air; and
an outlet for the treated air, the system further comprising:
a controller arranged to receive the output of the determining system, wherein the controller is operable to control system operation such that:
if the determined ozone level is below a primary threshold level of ozone, the controller is arranged to supply said treated air to the outlet, or
if the determined ozone level is above the primary threshold level of ozone, the controller is operable to perform a further treatment operation on the treated air, characterised in that the further treatment operation comprises
comparing the determined ozone level to an upper secondary threshold level of ozone and a lower secondary threshold level of ozone, the lower secondary threshold level less than the upper secondary threshold level, wherein:
when the determined level of ozone is greater than the lower secondary threshold level and less than the upper secondary threshold level, the controller is operable to perform a first treatment operation on the treated air, and
when the determined level of ozone is greater than the upper secondary threshold level, the controller is operable to perform a second treatment operation on the treated air.

15. (canceled)

16. The ozone treatment system of claim 14, wherein the system for determining the level of ozone in said treated air comprises a processor for calculating the level of ozone in the treated air based on at least one of the following factors: monitored ozone generation levels from an ozone generator; detected levels of other substances in the treated air; and flow rates of the intake air and/or the treated air.

17. The ozone treatment system of claim 14, further comprising a blower, wherein the controller is arranged to adjust the blower operation as part of a control operation.

18. The ozone treatment system of claim 14, wherein the system comprises an adjustable baffle or valve, wherein the controller is arranged to actuate said baffle or valve to redirect a flow of the treated air as part of a control operation.

19. The ozone treatment system of claim 14, wherein the system comprises at least one air filter arranged to filter intake air prior to supplying ozone to the intake air, or to filter treated air after supplying ozone to treated air.

20. The ozone treatment system of claim 14, wherein the lower secondary threshold level is selected from one of the following: 10 ppb, 25 ppb, 50 ppb of ozone; and the upper secondary threshold level is selected from one of the following: 55 ppb, 100 ppb, 150 ppb of ozone.

21. An agricultural vehicle such as an agricultural tractor or sprayer, having an ozone treatment system for a vehicle cab, the system comprising:
an air intake;
an ozone generator to supply ozone to intake air to provide treated air;
a system for determining the level of ozone in said treated air;
an outlet for the treated air; and
a controller arranged to receive the output of the determining system, wherein the controller is operable to control system operation such that if the determined ozone level is below a primary threshold level of ozone, the controller is arranged to supply said treated air to the outlet, and if the determined ozone level is above the primary threshold level of ozone, the controller is operable to perform a further treatment operation on the treated air, characterised in that the further treatment operation comprises:
comparing the determined ozone level to an upper secondary threshold level of ozone and a lower secondary threshold level of ozone, the lower secondary threshold level being less than the upper secondary threshold level, wherein:
when the determined level of ozone is greater than the lower secondary threshold level and less than the upper secondary threshold level, the controller is operable to perform a first treatment operation on the treated air, and
when the determined level of ozone is greater than the upper secondary threshold level, the controller is operable to perform a second treatment operation on the treated air.

22. An agricultural vehicle such as a tractor or sprayer, having a controller arranged to implement the method as claimed in claim 1.
